(19) United States
(12) Patent Application Publication
(10) Pub. No.: US 2007/0034717 A1
(43) Pub. Date: Feb. 15, 2007

(54) Paint sprayer

(76) Inventor: Gregory John Finley, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 11/331,531

(22) Filed: Jan. 13, 2006

Related U.S. Application Data
(63) Continuation-in-part of application No. 11/200,831, filed on Aug. 10, 2005, now abandoned.

(51) Int. Cl. A62C 13/62; B05B 7/30; B05B 9/04; B05B 9/00; B05B 9/01

(52) U.S. Cl. 239/302; 239/379; 239/526; 239/345; 239/346; 239/373

(57) ABSTRACT

A paint sprayer that overcomes these and other problems has a paint cup and a paint gun. An adjustable tubing connects the paint cup to the paint gun.

### RELATED APPLICATIONS

The present invention is a continuation-in-part of patent application Ser. No. 11/200,831, filed on Aug. 21, 2005, entitled “Verso Tube” and is hereby incorporated by reference.

### FIELD OF THE INVENTION

The present invention relates generally to the field of painting systems and more particularly to a paint sprayer.

### BACKGROUND OF THE INVENTION

Paint sprayers are used in variety of applications including house painting both inside and out and automotive painting. Paint sprayers use a source of air to push or pull paint from a paint reservoir and out a nozzle. Paint sprayers come in three main types: 1) siphon fed systems, 2) gravity fed systems and 3) High Volume Low Pressure (HVLP) systems. One problem that all these paint spraying systems suffer from is that the paint cup cannot be tilted beyond a certain angle without either having paint come out the vent hole or paint clogging the pressure tube in a HVLP system. As a result, paint sprayers cannot be used to paint items that require the paint sprayer to be tilted at extreme angles. This makes it difficult to paint the underside of horizontal surfaces or even the top surface. In addition, it makes it difficult to paint surfaces that may be under and inside an automobile.

Thus there exists a need for a paint sprayer that allows the user to tilt the paint spray at almost any angle necessary for the paint job.

### SUMMARY OF INVENTION

A paint sprayer that overcomes these and other problems has a paint cup and a paint gun. An adjustable tubing connects the paint cup to the paint gun. The paint gun may be a siphon fed system or a high volume low pressure system or a gravity fed system. The adjustable tubing may be a rubber hose or a corrugated metal tubing. The paint cup may have a vent hole. The adjustable tubing may be a flexible tubing having sufficient length to allow a 90° bend without crimping. In another embodiment, the adjustable tubing may have sufficient tension to hold the paint cup in an upright position when the paint sprayer is in use and may be a corrugated metal tubing.

In one embodiment, a paint sprayer has a paint cup and a paint gun. A corrugated metal tubing connects the paint cup to the paint gun. The paint gun may be a gravity fed system.

In another embodiment, a paint sprayer has a paint cup and a paint gun. A flexible tubing connects the paint cup to the paint gun. The flexible tubing may have sufficient length to allow a 90° bend without crimping. The paint gun may be a siphon fed system. The paint gun may be a high volume low pressure system.

### BRIEF DESCRIPTION OF THE DRAWINGS

FIG. 1 is a side view of a paint sprayer in accordance with one embodiment of the invention;

FIG. 2 is a side view of a paint sprayer in accordance with one embodiment of the invention;

FIG. 3 is a side view of a paint sprayer in accordance with one embodiment of the invention; and

FIG. 4 is a side view of a paint sprayer in accordance with one embodiment of the invention.

### DETAILED DESCRIPTION OF THE DRAWINGS

A paint sprayer that allows the user to paint at almost any angle without paint clogging or coming out of the vent hole or air tube has a length of adjustable tubing that connects the paint cup to the paint gun. The adjustable tubing allows the paint cup to be essentially upright while the paint gun is pointed in almost any direction. This makes the paint sprayer more versatile and increases the painting efficiency of the painter, who would otherwise have to paint these awkward spaces by hand.

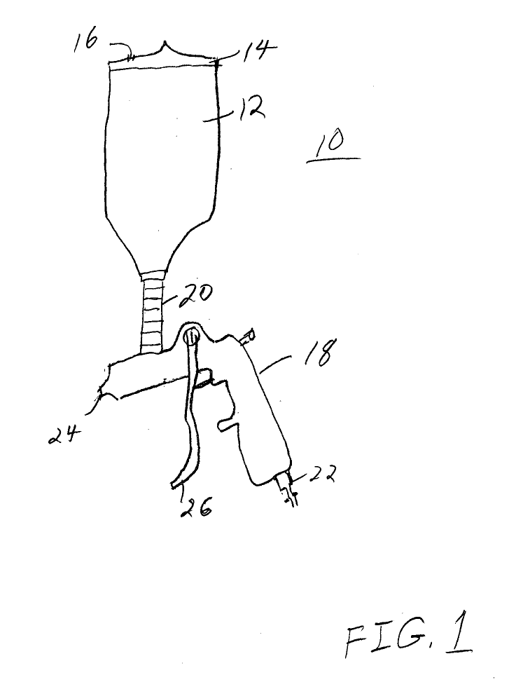

FIG. 1 is a side view of a paint sprayer 10 in accordance with one embodiment of the invention. This paint sprayer 10 is a gravity type system. The paint sprayer 10 has a paint cup 12 that holds the paint. The paint cup 12 has a lid 14 for placing paint in the paint cup 12. The lid 14 has a vent hole 16 that allows air into the paint cup 12. Without the vent hole 16, the paint would not flow continuously into the paint gun 18. The paint gun 18 is connected to the paint cup 12 by an adjustable tubing 20. The paint gun 18 has an air hose input 22 that is connected to a source of air. The air flows through the paint gun 18 and pushes the paint from the adjustable hose 20 out a nozzle 24. A trigger 26 controls a valve that allows or stops the flow of the air through the paint gun 18. In a gravity fed system as shown in this figure the adjustable hose 20 has to be able to hold the paint cup 12 in an upright position. One adjustable hose that has this capability is corrugated tubing, such as that used in natural gas lines. The user adjusts the angle of the tubing 20 so that the paint cup is upright no matter what the angle of the paint gun 18.

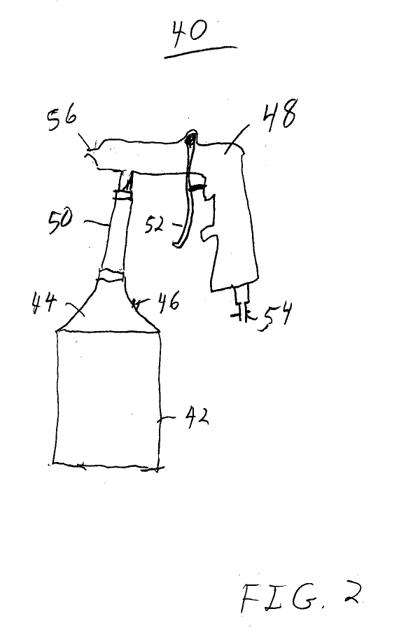

FIG. 2 is a side view of a paint sprayer 40 in accordance with one embodiment of the invention. This paint sprayer 40 is a siphon type system. The paint spray 40 has a paint cup 42. The paint cup 42 has a lid 44 with a vent hole 46. The paint cup 42 is connected to a paint gun 48 by a flexible tubing 50. The paint gun 48 has a trigger 52, a nozzle 54 and an air inlet 56. The flexible tubing 50 may be a rubber or plastic that is flexible and designed to hold the paint of interest. The flexible tubing 50 keeps the paint cup upright no matter what the angle of the paint gun 48.

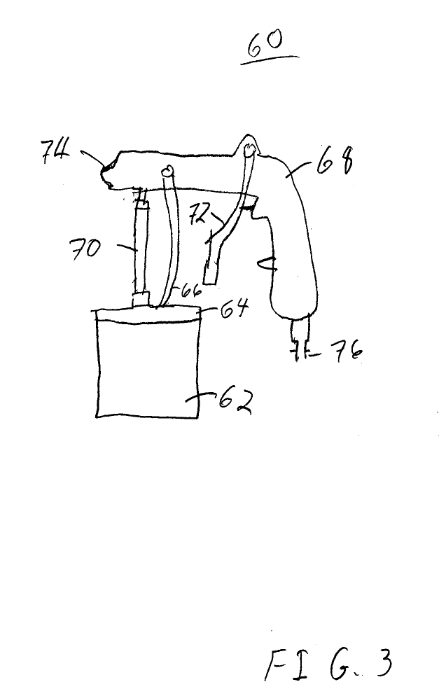

FIG. 3 is a side view of a paint sprayer 60 in accordance with one embodiment of the invention. This paint sprayer 60 is a High Volume Low Pressure (HVLP) system. The paint spray 60 has a paint cup 62. The paint cup 62 has a lid 64 with an air tube (pressure tube) 66. The paint cup 62 is connected to a paint gun 68 by a flexible tubing 70. The paint gun 68 has a trigger 72, a nozzle 74 and an air inlet 76. The flexible tubing 70 may be a rubber or plastic that is flexible and designed to hold the paint of interest. The flexible tubing 70 keeps the paint cup upright no matter what the angle of the paint gun 68.

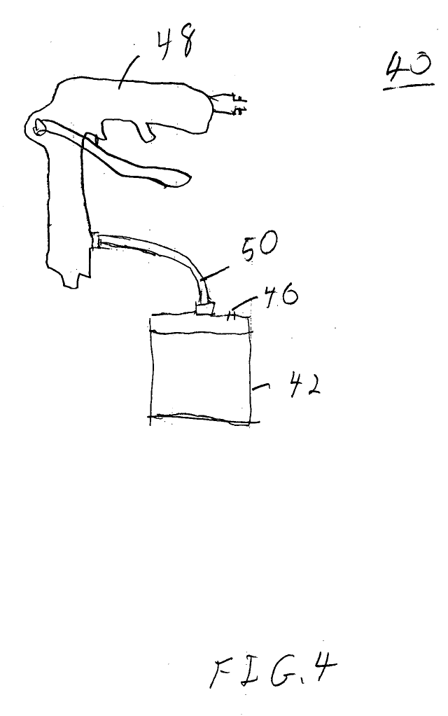

FIG. 4 is a side view of a paint sprayer 40 in accordance with one embodiment of the invention. This is the same type of paint sprayer 40 as shown in FIG. 2 but shows the spray gun 48 at a vertical angle. As shown in the figure the flexible tubing allows the paint cup 42 to remain in an upright position.

Thus there has been described a paint sprayer that allows the user to tilt the paint spray at almost any angle necessary for the paint job.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A paint sprayer comprising:
a paint cup;
a paint gun; and
an adjustable tubing connecting the paint cup to the paint gun.

2. The sprayer of claim 1, wherein the paint gun is a siphon fed system.

3. The sprayer of claim 1, wherein the paint gun is a high volume low pressure system.

4. The sprayer of claim 1, wherein the paint gun is a gravity fed system.

5. The spray of claim 1, wherein the adjustable tubing is a rubber hose.

6. The spray of claim 1, wherein the adjustable tubing is a corrugated metal tubing.

7. The sprayer of claim 2, wherein the paint cup has a vent hole.

8. The sprayer of claim 7, wherein the adjustable tubing is a flexible tubing having a sufficient length to allow a 90° bend without crimping.

9. The sprayer of claim 3, wherein the adjustable tubing is a flexible tubing.

10. The sprayer of claim 9, wherein the flexible tubing has a sufficient length to allow a 90° bend without crimping.

11. The sprayer of claim 4, wherein the adjustable tubing has sufficient tension to hold the paint cup in an upright position when the spray is in use.

12. The sprayer of claim 12, wherein the adjustable tubing is a corrugated metal tubing.

13. A paint sprayer, comprising:
a paint cup;
a paint gun; and
a corrugated metal tubing connecting the paint cup to the paint gun.

14. The paint sprayer of claim 13, wherein the paint gun is a gravity fed system.

15. A paint sprayer, comprising:
a paint cup;
a paint gun; and
a flexible tubing connecting the paint cup to the paint gun.

16. The sprayer of claim 15, wherein the flexible tubing has a sufficient length to allow a 90° bend without crimping.

17. The sprayer of claim 16, wherein the paint gun is a siphon fed system.

18. The sprayer of claim 16, wherein the paint gun is a high volume low pressure system.
